(19) United States
(12) Patent Application Publication
(10) Pub. No.: US 2010/0180246 A1
(43) Pub. Date: Jul. 15, 2010

(54) RANDOM GENERATION OF PLD CONFIGURATIONS TO COMPENSATE FOR DELAY VARIABILITY

(76) Inventors: Peter Ying Kay Cheung, London (GB); Nicholas Peter Sedcole, London (GB)

Correspondence Address: HICKMAN PALERMO TRUONG & BECKER, LLP, 2055 GATEWAY PLACE, SUITE 550, SAN JOSE, CA, 95110, US

(21) Appl. No.: 12/526,927

(22) PCT Filed: Feb. 15, 2008
(86) PCT No.: PCT/GB08/00537

§ 371 Date: Feb. 4, 2010

(51) Int. Cl. G06F 17/50; G06F 7/58

(52) U.S. Cl. 716/6; 716/16; 708/254

(57) ABSTRACT

A method of generating a user circuit implementation for programming a PLD comprising generating a set of user circuit implementation configuration candidates, measuring one or more characteristics of the PLD in a measurement phase and selecting a user circuit implementation from the set of candidates based on a measured characteristic.

### FIELD OF THE INVENTION

The invention relates to integrated circuit (IC) technology; specifically, the invention relates to the yield and performance of programmable logic devices that exhibit parametric variation.

### BACKGROUND OF INVENTION

The fabrication of semiconductor integrated circuits is a complex manufacturing process involving many steps. Each manufacturing step has many parameters, which must be precisely controlled to ensure the manufactured devices are as close as possible to being uniform in their characteristics. Any deviation from the ideal value in a process parameter may cause a deviation from the ideal characteristic in the manufactured product, which is referred to as process variation.

Process variations can arise from imperfections in the control of mechanical, electromagnetic or chemical aspects of the fabrication process. For example, variations in the alignment of semiconductor wafers in the fabrication equipment, vibrations during fabrication, variations in lithographic exposure time or intensity and variations in dopant concentrations all cause parametric process variations in the resultant products.

Process variation is also caused by the innate randomness of the materials used in fabrication. All fabrication materials are granular when examined at small enough scales, as they are constructed from individual atoms. Random variations in the locations of individual atoms within a device result in parameter variation. This effect becomes more significant as device feature sizes approach atomic scales. The dimensions of features such as transistor gate lengths and wire widths in contemporary advanced integrated circuits are less than 100 nanometres, while gate oxide thicknesses are only a few nanometres.

Whereas process variation has always existed to some degree in integrated circuits, it was previously only significant between dice (or chips). That is, the characteristics of a transistor or a wire may differ from die to die, but do not differ significantly when compared to other transistors or wires on the same die. As feature sizes are scaled to below 100 nm, the variation of transistor and wire characteristics within the same die is expected to become more significant.

Increases in process variation can result in a loss of performance and a reduction in yield. The overwhelming majority of advanced integrated circuits are synchronised to a clock signal which usually operates at a predetermined rate. The maximum speed, or maximum clock rate, of the circuit is determined by the slowest signal path in the circuit. If increased process variation causes an increase in the spread of signal delays, the result will be a reduction in the maximum clock rate at which the circuit operate correctly. In situations where a certain minimum clock rate is required, chips failing to reach the required clock rate are considered non-functioning and are discarded. Therefore increased process variation can lead to a reduction of the manufacturing yield of integrated circuits.

Apart from operating speed, another specification common in integrated circuits is the maximum chip power consumption. This is also affected by parameter variation and therefore reduction the manufacturing yield.

Programmable Logic Devices (PLDs), which include Field-Programmable Gate Arrays (FPGAs), are a type of digital integrated circuit where the circuit functions are not completely defined during manufacturing. The exact function of the logic circuits within a PLD is determined by the user by programming the device. The programming file is known as a “configuration bitstream”, and is generated by the execution of a CAD (computer-aided design) tool flow which includes a “place and route” step and a “bitstream generation step”. The execution tune of the CAD tool flow for a latest-generation PLD is typically many minutes to several hours, even on a high-end workstation.

As integrated circuits, PLDs are susceptible to process variations. However, PLDs which can be programmed more than once (such as SRAM-based FPGAs) have two advantages over other types of IC. Firstly, a given PLD can be programmed with self-test circuitry to analyse the PLD's characteristics, say, at power-up time, and then subsequently re-programmed for the required circuit functions. In this way, the initial self-test procedure does not require extra circuitry and therefore incurs no extra hardware cost. Secondly, PLDs generally consist of regular array of programmable logic modules which can be configured to perform different logic functions. Therefore given a particular design and circuit function, it can be placed onto a PLD in a plurality of physical locations on the chip. In other words, the mapping between circuit functions and the actually hardware is not fixed during manufacturing, but can be changed after the device has been deployed, during power-up, or even while it is function in-situ.

Therefore, for a given PLD, a circuit implementation can be selected, based on the information from the analysis testing, which compensates for the process variation present in the PLD.

A naïve approach to achieve this would be to create a unique circuit implementation for each target PLD. This would involve invoking the CAD tool flow for each PLD, and supplying the tools with the measurement data. Although this approach would be capable of producing the best possible circuit implementation for each PLD, it would be too time consuming to be used in a practical manufacturing operation.

### SUMMARY OF THE INVENTION

The object of the invention is to provide a means for compensating for within-die parametric variations in programmable logic devices, without requiring the execution of time-consuming CAD algorithms for each PLD. The invention comprises a method of two steps. In the first step, a collection of configurations are generated. When used to program a PLD, the configurations implement functionally identical versions of a required user circuit.

The second step of the method is invoked at each time a PLD is to be programmed with the user circuit, and involves two phases. The first is a measurement phase, whereby the PLD is programmed with self-test circuitry, from which measurements are made of characteristics of the PLD. Measured characteristics may include, but are not limited to, performance, power consumption and electromagnetic noise generation. The PLD may be reprogrammed with different self-test circuits one or more times during the measurement phase.

The second phase consists of selecting an appropriate implementation of the user circuit, based on the data obtained from the measurement phase. The implementation is selected from the collection of configurations generated during the first step of the method.

In one embodiment of the invention, the configurations generated in step one of the method are full configuration design files. These may be stored as configuration bitstreams or in a form from which configuration bitstreams can be quickly generated.

In another embodiment of the invention, in step one of the method the user circuit is spatially subdivided into two or more parts. Partial configurations are generated for each part of the user circuit, and stored as configuration bitstreams or in a form from which configuration bitstreams can be quickly generated. During step two of the method, a full configuration for the user-circuit is constructed by assembling an appropriate selection of partial bitstreams.

### BRIEF DESCRIPTION OF THE DRAWINGS

FIG. 1: Generating multiple full configurations as part of step one of the method.

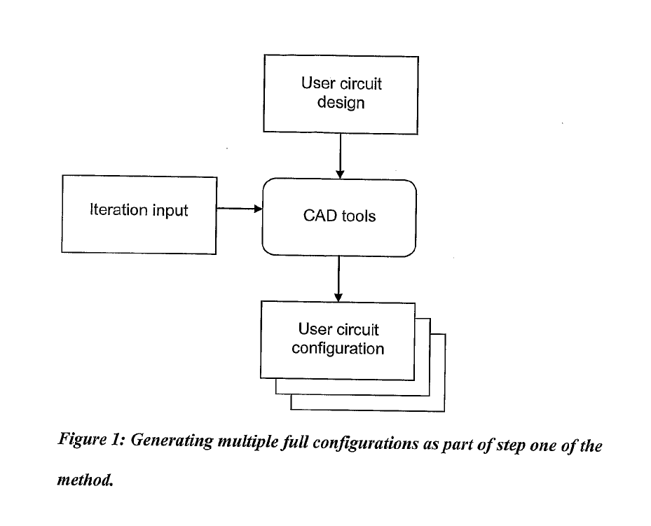

FIG. 2: Generating multiple partial configurations as part of step one of the method.

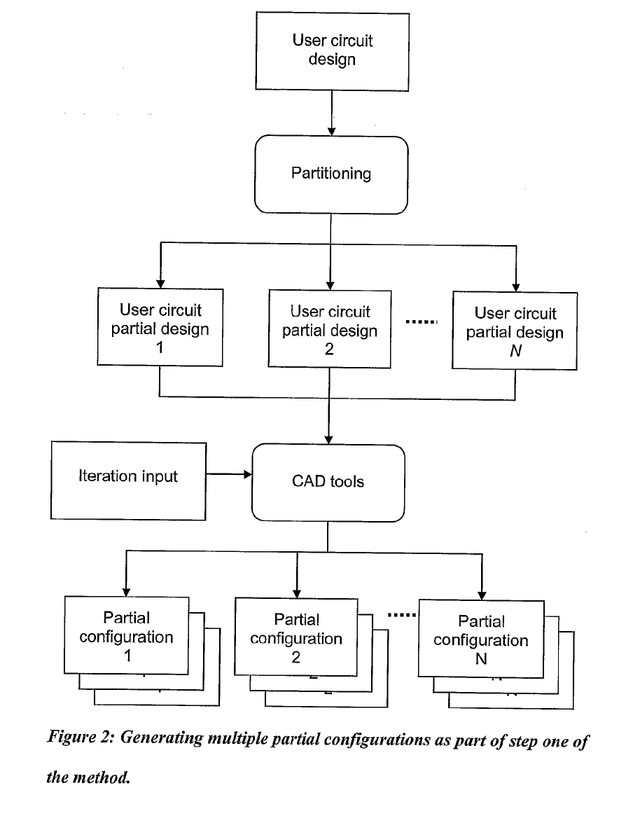

FIG. 3: Possible test measurement and data capture embodiments.

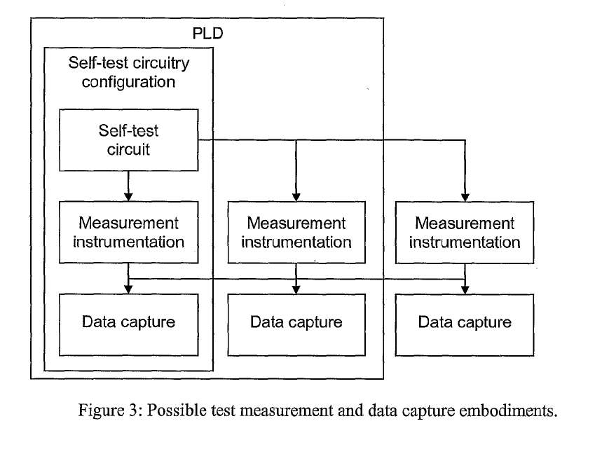

### DETAILED DESCRIPTION OF THE PREFERRED EMBODIMENTS OF THE INVENTION

The invention consists of a method of two steps. The first step is executed once, during the design and implementation of the user circuit. The second step is executed for each PLD that is to be programmed with the user circuit.

The first step of the method is typically executed using a computer workstation running the CAD tools appropriate for the type of PLD to be programmed with the user circuit. The user circuit design is created in whatever way desired in a form suitable for input to the CAD tools.

For the purposes of this invention, the function of user circuit is only restricted by what can be implemented in a given PLD. The circuit may or may not be synchronous. One illustrative example of a possible user circuit is an MPEG encoder, which comprises three main circuit blocks: a motion-vector estimation circuit, a motion-compensation circuit, and a Huffman encoder circuit.

In one embodiment, the CAD tool flow, including place and route, is executed two or more tunes or iterations. Before each execution, an iteration input to the CAD tools is altered in a way which does not affect the functionality of the user circuit, but changes the way resources inside the PLD are assigned to the user circuit. This may include, but is not limited to, changing the value of a seed used to generate pseudo-random numbers in the CAD tools, or altering user constraints. The output of the CAD flow for each iteration is a configuration. The configuration includes data, which may be a configuration bitstream or may be in a format from which a configuration bitstream can be quickly derived. Each generated configuration is called a candidate configuration.

An example of changing pseudo-random seed values in CAD tools is as follows. CAD place and route tools determine the assignment of logic elements to physical locations within a PLD (placement) and which wires within the PLD are used to connect logic together (routing). The decisions are generally too complex to perform optimally. Therefore, heuristic methods such as simulated annealing are used, which include pseudo-random processes. Different initial (or seed) values of the pseudo-random number generator will result in the CAD tools assigning logic to different physical locations and selecting different wire paths for signals. However, the function of the circuit will be unchanged.

The following is an example of changing user constraints. User constraints are specifications for the circuit which are not part of the functionality of the circuit. The constraints are specified by the user and obeyed by the CAD tools. An example of a user constraint is a floor-planning information, which specifies restrictions on the physical locations inside the PLD that may be used for a given part of the user circuit. In the previous example of the MPEG encoder circuit, the three main circuit blocks can be constrained to occupy different regions of the PLD by changing the user constraints, which then results in different implementations. Again, the function of the circuit will be unchanged.

In another embodiment of the invention, the user circuit is first partitioned into several partial designs. Each partial design is then input to the CAD tools one or more times. Before each execution of the CAD tools, an iteration input to the CAD tools is altered in a way which does not affect the functionality of the partial user circuit, but changes the way resources inside the PLD are assigned to the partial user circuit. The output of the CAD flow is a plurality of partial configurations corresponding to each partial user design. Each partial configuration includes data, which may be a partial configuration bitstream or in a format from which a partial configuration bitstream can be quickly derived. Any set of partial configurations that may be assembled into a valid full configuration is known as a candidate configuration.

In the previous example where the user circuit is an MPEG encoder, the circuit could be partitioned into three parts: (1) the motion-vector estimation circuit, (2) the motion-compensation circuit, and (3) the Huffman encoder. The previous examples of changing the seed of a pseudo-random number generator or modifying floor-planning information are also relevant examples of possible changes to an iteration input for this second embodiment of the invention.

An example how the assembly of a set of partial configurations into a full configuration can be achieved is the use of partial dynamic reconfiguration. In some PLDs, notably the Xilinx Virtex family of FPGAs, part of the PLD can be re-programmed while the rest of the PLD continues to operate undisturbed. This is partial dynamic reconfiguration (also known as partial reconfiguration, dynamic reconfiguration, or run-time reconfiguration) and uses a specially constructed partial bitstream. The full bitstream of a candidate configuration can be constructed by programming the PLD with each of the partial bitstreams which make up the candidate configuration one at a time.

In another embodiment of the invention, both full and partitioned configurations are generated as previously described. This embodiment is a combination of the two previous embodiments. Any full configuration or set of partial configurations which may be assembled into a full configuration is called a candidate configuration for this embodiment.

In any of the embodiments of the invention, all possible candidate configurations obtainable from the generated full and partial configurations are the set of candidate configurations.

Each candidate configuration will have different characteristics of signal delay, power consumption and so on, for a given PLD. The characteristics of a candidate configuration depend on which resources of the PLD are used, how they are used, and the properties of the used resources for the given PLD.

In step two of the method a given PLD is to be programmed with the user circuit. Step two of the method has two phases. In the first phase, the given PLD is measured. Measurements are achieved by programming the PLD with self-test circuitry. The self-test circuitry exercises the PLD in such a way so as to make it possible to determine differences in a measured quantity of interest at different locations within the die. The measured quantity of interest may be, but is not limited to, the propagation delay of a signal along an electrical path, the electrical power or energy dissipated, or the electromagnetic noise or signals generated. The self-test may be generic, in that it is not dependent on the user circuit, or it may be specific to a user circuit configuration or partial configuration.

In one embodiment of the invention, the measurement instrumentation for detecting the quantity of interest is included in the self-test circuitry. In another embodiment of the invention, the measurement instrumentation for detecting the quantity of interest is built into the PLD. In another embodiment of the invention, the measurement instrumentation for detecting the quantity of interest is off-chip.

The output of the measurement instrumentation is captured by a data capture recorder. In one embodiment of the invention, the data capture is performed by the self-test circuitry. In another embodiment of the invention, the data capture recorder is built into the PLD. In another embodiment of the invention, the data capture recorder is off-chip.

As an example, an array of ring oscillators can be used as a self-test circuit that measures propagation delay. The frequency of oscillation of each ring oscillator is inversely proportional to the propagation delay of the logic and wires from which the ring oscillator is constructed from. Therefore by measuring the oscillation frequency it is possible to calculate the propagation delay. The measurement instrumentation may consist of a synchronous counter which uses the output of a ring oscillator as the clock and which is reset and then enabled for a precisely controlled time interval. The value of the counter after the time interval is proportional to the frequency of oscillation and therefore inversely proportional to the propagation delay of the ring oscillator. The data capture recorder stores the measured counter value for each ring oscillator in the array. This example of measurement circuitry is described in the paper “Within-die Delay Variability in 90 nm FPGAs and Beyond”, in Proc. International Conference on Field Programmable Technology, 2006.

In another example of self-test circuitry the test may be specifically designed to measure propagation delays along electrical paths which are used by a given configuration or partial configuration. The PLD is programmed with a test circuit containing one or more paths matching those in the user circuit configuration. The test can be performed by at-speed scan testing techniques well-known in the industry.

In the second phase of step two of the method, the captured data is used to determine an appropriate candidate configuration with which to program the PLD. In one embodiment of the invention, the processing required to make the decision may be performed on the PLD. In another embodiment, an off-chip processor or computer may be used to make the decision.

The selection process calculates the relevant characteristic or characteristics of one or more candidate configurations for the measured PLD. One candidate configuration is then selected to program the PLD.

In one embodiment, all candidate configurations are considered and the best chosen. In another embodiment, candidate configurations are inspected until one is found which meets predefined criteria.

In the case where the self-test circuitry is not specific to a user circuit, the captured test results are combined with information from each candidate configuration to be considered. In the case where the self-test circuitry is designed to test a specific configuration or partial configuration the captured test results can be used directly.

For example, non-specific self-test circuitry to measure propagation delay produces data from which the propagation delay of each part of the PLD can be determined. The speed at which a given candidate configuration will run at is then calculated by adding together the derived propagation delays of the circuit elements on the critical paths of the candidate configuration.

1. A method of generating a user circuit implementation for programming a programmable logic device (PLD) comprising generating a set of user circuit implementation configuration candidates, measuring one or more characteristics of the PLD in a measurement phase and selecting a user circuit implementation from the set of candidates based on a measured characteristic.

2. A method as claimed in claim 1 in which a particular user circuit implementation configuration candidate in the set comprises a partial candidate for constructing a user circuit implementation in conjunction with one or more additional partial candidates.

3. A method as claimed in claim 2 further comprising constructing a user circuit implementation from a plurality of selected partial candidates.

4. A method as claimed in claim 2 further comprising constructing a user circuit implementation based on the selected candidate.

5. A method as claimed in claim 1 in which a user circuit implementation configuration candidate is generated by identifying a desired user circuit, executing a design process in relation to the desired user circuit for a plurality of iterations and constructing a respective user circuit implementation configuration candidate for each iteration.

6. A method as claimed in claim 5 in which an iteration input is selected so as not to affect functionality of the desired user circuit

7. A method as claimed in claim 6 in which the iteration input comprises a seed value used to generate pseudo random numbers or a user constraint.

8. A method as claimed in claim 1 further comprising programming a selected user circuit implementation on to a PLD.

9. A method as claimed in claim 1 in which a user circuit implementation configuration candidate is generated during a self test process.

10. A method as claimed in claim 9 in which the self test process comprises measuring one or more quantities at different locations within the PLD.

11. A method as claimed in claim 9 in which the measured quantities comprise one of propagation delay of a signal along an electrical path, electrical power or energy dissipated, electro magnetic noise generated or electro magnetic signal generated.

12. A method as claimed in claim 10 and further comprising capturing the one or more measured quantities on a data capture recorder.

13. A method as claimed in claim 12 in which the capturing is performed by self test circuitry resident on the PLD, a data capture recorder provided on the PLD or an external data capture recorder.

14. A method as claimed in claim 13 in which the self test circuitry comprises one or more ring oscillators for measuring propagation delay.

15. A method as claimed in claim 14 in which a data capture component comprises a synchronous counter using an output of a ring oscillator as a clock for measuring propagation delay.

16. A method as claimed in claim 9 further comprising generating a user circuit implementation configuration candidate based on measurements from the self test process.

17. A method as claimed in claim 16 in which the candidate is generated based on a decision process performed on a PLD or an external processor or computer.

18. A method as claimed in claim 1 in which the selected configuration candidate comprises the optimum candidate.

19. A method as claimed in claims 1 in which the selected configuration candidate comprises a first acceptable inspected candidate.

20. A method as claimed in claim 1 in which the PLD comprises a field programmable gate array (FPGA).

21. A method as claimed in claim 1 in which each of the configuration candidates comprises a configuration bit stream or precursor thereof.

22. A programmable logic device (PLD) constructed by generating a set of user circuit implementation configuration candidates, measuring one or more characteristics of the PLD in a measurement phase and selecting a user circuit implementation from the set of candidates based on a measured characteristic, wherein the PLD comprises a FPGA.

23. A PLD as claimed in claim 22 further comprising a least one of self test circuitry, measurement circuitry, capture circuitry and candidate generation circuitry.

24. A PLD as claimed in claim 23 comprising an array of ring oscillators as a self test circuit for measuring propagation delay.

25. A PLD as claimed in claim 24 further comprising a synchronous counter for measuring propagation delay in conjunction with the array of ring oscillators.

26. An apparatus for generating a user circuit implementation for programming on to a PLD comprising a processor configured for generating a set of user circuit implementation configuration candidates, a measurement component for measuring one or more characteristics of the PLD in a measurement phase and a selection component for selecting a user circuit implementation from the set of candidates based on a measured characteristic.

27. A computer readable medium storing a set of instructions which when executed on a processor cause performing: generating a user circuit implementation for programming a programmable logic device (PLD) by generating a set of user circuit implementation configuration candidates, measuring one or more characteristics of the PLD in a measurement phase and selecting a user circuit implementation from the set of candidates based on a measured characteristic.
